(19) United States
(12) Patent Application Publication
(10) Pub. No.: US 2023/0145359 A1
(43) Pub. Date: May 11, 2023

(54) METHOD FOR MONITORING A WIND TURBINE, SYSTEM FOR MONITORING A WIND TURBINE, WIND TURBINES, AND COMPUTER PROGRAMME PRODUCT

(71) Applicant: fos4X GmbH, München (DE)

(72) Inventors: Amr Balbaa, München (DE); Luis Vera-Tudela, München (DK)

(73) Assignee: fos4X GmbH, München (DE)

(21) Appl. No.: 17/918,213

(22) PCT Filed: Apr. 15, 2021
(86) PCT No.: PCT/EP2021/059729

§ 371 Date: Oct. 11, 2022

(30) Foreign Application Priority Data
Apr. 23, 2020 (DE) 10 2020 111 142.8

(51) Int. Cl. F03D 17/00; F03D 7/04

(52) U.S. Cl. CPC F03D 17/00; F03D 7/046

(57) ABSTRACT

A method for monitoring a wind turbine (10) is disclosed. The method comprises: collecting data that is associated with an abnormal behaviour of the wind turbine; comparing the collected data with anonymized data from other wind turbines; matching a fault condition with the abnormal behaviour through the comparison; and outputting the fault condition to the wind turbine.

### TECHNICAL FIELD

The present disclosure relates to a method for monitoring a wind turbine, a system for monitoring a wind turbine, a wind turbine and a computer program product. In particular, the present disclosure relates to methods for monitoring a wind turbine, for which a behaviour from one wind turbine can be compared with anonymized data from other wind turbines. Furthermore, the present invention generally relates to methods for monitoring devices, in particular machines, for which a behaviour of a device can be compared with anonymized data from other devices.

### TECHNICAL BACKGROUND

The emergence of machine learning as a common technique for improving wind turbine operation is largely dominated by the supervised learning concept. This means that the models are developed based on tagged data, Le, in cases where the developers have a sufficient number of events for the faults they want to model.

For measurements that appear to represent the failure event being modelled, most of the developer's effort is focused on cleaning up and assessing whether the collected measurements statistically represent the event being modelled. This means that most of the effort is focused on non-trivial preprocessing tasks.

So far, for example, reactive strategies (common, little effort, known result) have been used. Here market participants are forced to wait until they collect enough interesting events that have a low probability of occurrence. Typically, the unsupervised learning (clustering) approach is used as a replacement for low value. The clustering approach aims to find anomalies in the process of interest. Here the technicians are expected to inspect the machines to tag the records for later use in automated monitoring.

A proactive strategy (unusual, large effort, unknown result) presented another alternative. Here market participants are looking for peers in the industry who may have complementary data. In their search, they were able to find a participant who may have data and is open to sharing it. Negotiations are initiated to find a common legal framework for sharing and exchanging the data, Only then do they undertake a complex cross-data assessment, mostly focused on cleaning and formatting the data, to ultimately assess whether the data is representative and sufficient for modelling the process in question.

A predictive strategy (unusual, large effort, known result) presented another alternative. Market participants start with large-scale simulations to represent failure modes through simulations. The intent behind this practice is to train simple models capable of recording expected unusual but predictable events. Ideally, models made to detect simulated events will be as good as the simulations mimicking reality.

Most market participants focus on the concept of computational big (big) data as a strategy for model development. However, since failure events have a low probability of occurring, they could be strategically flawed, more data means no access to relevant data.

Experience shows that due to the lower probability of default events and the limited number of data sets held by individual market participants, there is usually not enough data at a market participant, Sufficient failure events are expected to be scattered across the market and owned by different market participants. So far, however, an exchange seems difficult.

It is therefore desirable to improve wind turbines and wind farms in such a way that data is made more available in order to be able to make significant statements.

### SUMMARY

Embodiments of the present disclosure provide a method for monitoring a wind turbine according to claim 1, a system for monitoring a wind turbine according to claim 8, wind turbines according to claims 9 and 10 and a computer program product according to claim 11.

According to an embodiment of the present disclosure, a method for monitoring a wind turbine is provided. The method comprises: collecting data that is associated with behaviour, in particular abnormal behaviour, of a wind turbine; comparing the collected data with anonymized data from other wind turbines; matching a condition, in particular a fault condition, with the (abnormal) behaviour through the comparison; and outputting the (fault) condition to the wind turbine.

According to an embodiment of the present disclosure, a system for monitoring a wind turbine is provided. The system is set up to carry out a method comprising: collecting data that is associated with behaviour, in particular abnormal behaviour, of a wind turbine; comparing the collected data with anonymized data from other wind turbines; matching a condition, in particular a fault condition, with the (abnormal) behaviour through the comparison; and outputting the (fault) condition to the wind turbine.

According to a further embodiment of the present disclosure, a wind turbine is provided. The wind turbine comprises at least one sensor for collecting data that is related to behaviour, in particular abnormal behaviour, of a wind turbine, and a data processing device. The data processing device is set up for: comparing the collected data with anonymized data from other wind turbines; matching a condition, in particular a (fault) condition, with the (abnormal) behaviour through the comparison; and outputting the (fault) condition to the wind turbine.

According to a further embodiment of the present disclosure, a wind turbine is provided. The wind turbine comprises at least one sensor for collecting data that is related to behaviour, in particular abnormal behaviour, of a wind turbine, and a data processing device. The data processing device is set up for: Sending the collected data for comparison with the collected data with anonymized data from other wind turbines and matching a (fault) condition with the (abnormal) behaviour through the comparison; and receiving the (fault) condition.

According to a further embodiment of the present disclosure, a computer program product is provided. The wind turbine includes an algorithm that is set up to carry out the following based on collected data that is related to an, in particular abnormal, behaviour of a wind turbine: matching a (fault) condition with the (abnormal) behaviour through the comparison; and outputting the (fault) condition to the wind turbine.

### BRIEF DESCRIPTION OF THE DRAWINGS

Embodiments of the invention are illustrated in the drawings and will be explained in more detail in the following description. In the drawings:

FIG. 1 shows a schematic example of a wind farm with three wind turbines according to the embodiments described herein;

FIG. 2 shows an exemplified wind turbine according to embodiments;

FIG. 3 shows a flow chart to illustrate an exemplary method for monitoring a wind turbine according to embodiments;

FIG. 4 shows an exemplary system with a wind turbine and an online-based storage and server service according to embodiments;

FIG. 5 shows an exemplary system for monitoring a wind turbine according to embodiments; and

FIG. 6 shows an exemplary interface of a computer program product according to embodiments.

### DESCRIPTION OF EMBODIMENTS

Embodiments of the present disclosure will be explained in more detail in the following. The drawings serve to illustrate one or more examples of embodiments. In the drawings, the same reference numerals designate the same or similar features of the respective embodiments. Features which are described as part of an embodiment can also be used in connection with another embodiment and thus form a further embodiment.

As mentioned initially, individual market participants often do not have sufficient data due to the lower probability of failure events and the limited number of data sets. However, enough failure events could be scattered across the market and be owned by different market participants

For example, an independent service provider (ISP) wants to predict pitch bearing failures for a large fleet of wind turbines. This is a common failure that the ISP has experienced before. However, the ISP only started recording vibration measurements a year ago and has only flagged two events in the database. The ISP is forced to wait for more events to be able to build a model to represent such an event. The alternative is to look for partners with potentially complementary data.

Embodiments of the present disclosure provide the ISP with a possibility of comparing its events with a larger set of anonymized data from other providers in order to make a statement about its events.

In addition, the systems, processes, devices and products presented here can become the point of contact for data collection from wind turbines. These can also be used for buying data to model normal behaviour (e.g. using a digital twin) and analyze the anomalies through unsupervised learning. Depending on design constraints, it could be open to store larger data sets of normal operations or normal behaviour to allow developers to take full advantage of the digital platform. Examples of uniquely large data sets that are rarely shared are measurements with LIDAR, videos of failures, results of complex numerical simulations, etc.

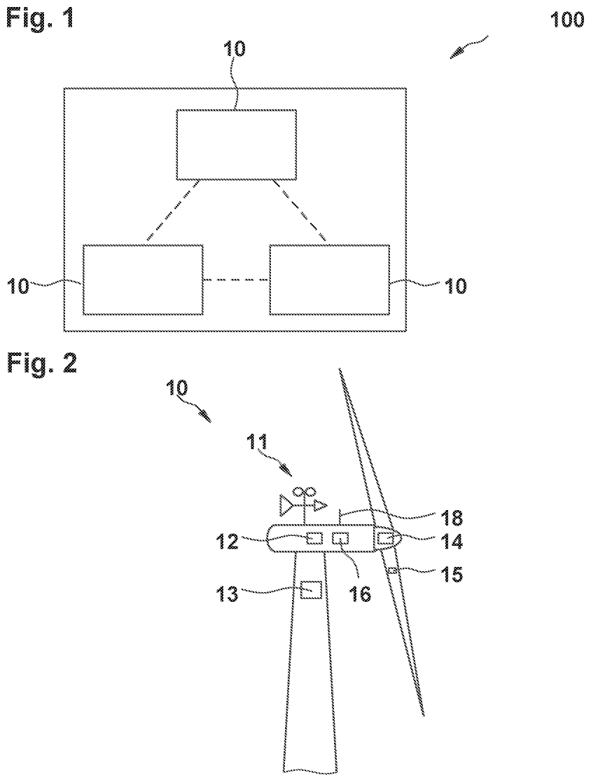

FIG. 1 shows a wind farm 100 with three wind turbines 10 as an example. The wind turbines 10 are, as shown in FIG. 1, in a network with one another, as shown by dashed lines. The network enables communication, for example real-time communication, between the individual wind turbines. The network also enables joint monitoring, control and/or regulation of the wind turbines. In addition, the wind turbines can also be monitored, controlled and/or regulated individually. According to embodiments described here, a wind farm can contain two or more wind turbines, in particular five or more wind turbines, such as ten or more wind turbines.

The wind turbines 10, for example the wind turbines in FIG. 1, together form the wind farm 100. The wind farm comprises at least two wind turbines, which are spaced apart.

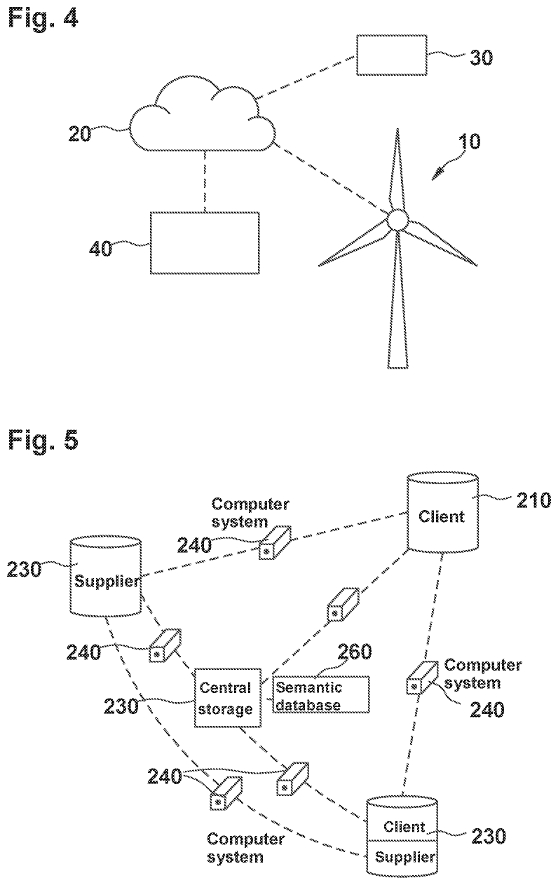

FIG. 2 shows an exemplified wind turbine 10. As an example, several sensors 11, 12, 13, 14, 15 are arranged on the wind turbine 10 according to FIG. 1. Sensor 11 can be a wind speed meter, for example. The sensors 11, 12, 13, 14 and 15 can collect data. The data can be relevant as regards the operation of the wind turbine. Furthermore, a data processing device 16 can be provided. The data processing device 16 can process the collected data. The collected data can be transmitted via a network interface 18. The network interface 18 can particularly be configured for connecting the data processing device to a data network. The network interface can be configured to send data processed by the data processing device 16 to an online-based storage and server service (reference numeral 20 in FIG. 4). In particular, the collected load data can be sent.

Sensors 12, 13, 14 and 15 can be sensors that record measurement data for a variety of parameters, for example a rotor, a transmission or a generator on the wind turbine. One or more sensors 11, 12, 13, 14 and 15 can be arranged on a wind turbine, Consequently, the present disclosure, unless otherwise explicitly indicated, always has at least one sensor or a combination of several sensors, also when “sensor” is only used in the singular for simplicity.

Thus, according to embodiments described herein, a sensor 11, 12, 13, 14, 15 can be arranged on the wind turbine. The sensor 11, 12, 13, 14, 15 can be arranged on a rotor blade of the wind turbine, on a turbine of the wind turbine, on a transmission of the wind turbine, on a tower of the wind turbine etc. or can be an external sensor. The sensor 11, 12, 13, 14, 15 can be a load sensor 11, 12, 13, 14, 15.

The sensor 11, 12, 13, 14, 15 can be an optical sensor, for example. According to embodiments described herein, the sensor 12, 13, 14, 15 can be a fiber optical sensor. In particular, the sensor 12, 13, 14, 15 can be a fiber optical strain sensor, acceleration sensor or vibration sensor.

According to embodiments described herein, at least one virtual sensor can be provided at a location of the wind turbine 10, where no sensor is arranged, using a data-based, model-based and/or hybrid approach from the collected load data or a physical model of the wind turbine. In particular, this can offer the advantage that the remaining useful life can be estimated or more precisely estimated for systems that have few sensors.

The sensor 11, 12, 13, 14, 15 can be connected to the data processing device 16. The sensor 11, 12, 13, 14, 15 can, for example, be connected to the data processing device 16 via a wired or a wireless connection. If the sensor 11, 12, 13, 14, 15 and the data processing device 16 are arranged on parts of the wind turbine 10 that are moveable against each other, such as for example the rotor and the nacelle, a wireless connection can be advantageous. A wireless link can be established via radio, in particular via a Bluetooth standard or WLAN standard, for example.

The data processing device 16 can use and/or be a digital processing unit (“DPU”), for example. According to embodiments described herein, the data collected by the sensor may be primary data. The data processing device 16 can be set up to process the primary data. This can also be done automatically and autonomously. In particular, the data processing device 16 can be set up to process the primary data into secondary data. Furthermore, the network interface 18 can be set up to send the secondary data. In practice, the amount of data to be sent can thus be reduced. According to embodiments described herein, the data collected, processed and/or to be sent cannot be SCADA data. In practice, the system can be independent of SCADA data, although SCADA data can flow in as an additional source of information.

Alternatively or additionally, the network interface 18 can be set up to send the primary data. Then the data processing can take place in the online-based storage and server service 20, In practice, the raw data can be kept available, for example in the event that a new evaluation option arises later.

According to embodiments described herein, the primary data and/or the secondary data can be related to a behaviour, in particular an abnormal behaviour, of the wind turbine 10, For example, the primary data and/or the secondary data can be used in connection with normal data, in particular for the creation of normal models. For example, primary data and/or the secondary data related to abnormal data can be used to exchange low-probability events to build abnormal models.

According to embodiments described herein, the data processing device 16 can be set up to process the collected data in real time. Furthermore, the network interface 18 can be set up to send the processed data in real time. Real-time monitoring of the wind turbine 10 can thus be achieved in practice. Alternatively or additionally, the processed data can be downsampled for transmission.

For the sake of simplicity, the network interface 18 is shown in FIG. 1 as an antenna. However, the network interface 18 can be any suitable network interface and can itself have logic circuitry or processor circuitry. According to embodiments described herein, the network interface 18 may use a mobile communications standard. However, the network interface 18 can also use a wired standard, such as a telephone line or a DSL line.

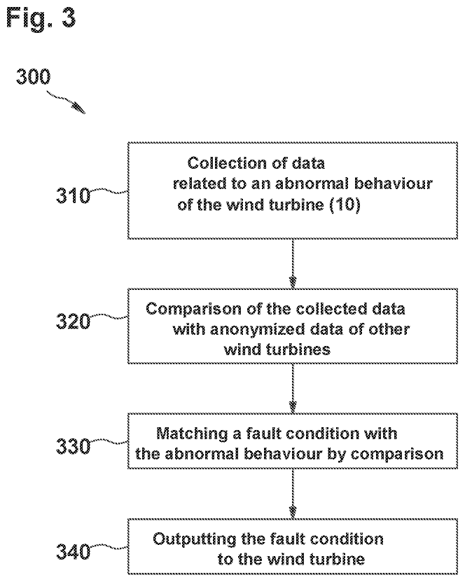

According to embodiments described herein, a wind turbine 10 can be monitored. FIG. 3 shows a flow chart to illustrate an exemplary method 300 for monitoring a wind turbine according to embodiments.

According to a box 310, data related to an abnormal behaviour of the wind turbine 10 can be collected. This data can, for example, be collected with the sensors 11, 12, 13, 14, 15, but it can also be video data, SCADA data, vibration data, etc.

According to a box 320, the collected data can be compared with anonymized data from other wind turbines.

According to a box 330, a fault condition can be matched with the abnormal behaviour by the comparison.

According to a box 340, the fault condition can be output to the wind turbine 10.

Although a method of monitoring a wind turbine 10 is shown and described herein, the present disclosure may be applied to other devices, particularly other machines.

Also, though data collection related to an abnormal behaviour of the wind turbine 10 is shown in FIG. 3, normal data can additionally or alternatively be collected and exchanged. If normal data is used, a condition of the wind turbine 10 can generally be associated with normal behaviour and this condition can be output.

In the context of the present disclosure, an “abnormal” behaviour can be understood as a behaviour of the wind turbine 10 that lies outside of the normal operating parameters. In particular, the abnormal behaviour can correspond to a fault in the wind turbine 10 that is to be identified.

The fault to be identified can relate to a subsystem of the wind turbine, such as a generator or a pitch bearing. In particular, the present disclosure can be used to match the fault with the fault location. In practice, data can thus be processed and a fault in a specific part of the wind turbine and/or a specific type of fault can be matched with this data as a possible fault condition. According to embodiments described herein, the fault to be identified may relate to a component or subsystem to which the sensor collecting the data is mechanically coupled or on which the sensor is mounted.

According to embodiments described herein, the data processing device 16 can be set up to carry out this and also other processes or operations of the wind turbine 10. In particular, the processes can be carried out automatically and/or autonomously. For example, the processes can be performed without operator, calibration, and/or corrections. Thus, the system can be set up as a plug-and-play and/or plug-and-forget.

FIG. 4 shows a system with a wind turbine 10 and an online-based storage and server service 20, such as a cloud, according to embodiments described herein. The wind turbine can for example be the wind turbine from FIG. 1.

As shown in FIG. 4, the wind turbine 10 can be connected to the online-based storage and server service 20 via a data connection. The data connection can have been set up via the network interface 18 of the wind turbine 10, The online-based storage and server service 20 can have a corresponding interface for establishing the data connection.

According to embodiments described herein, the comparison and the matching can be performed centrally on the online-based storage and server service 20. For example, the computing power provided by the online-based storage and server service 20 can be used to perform the processes quickly and efficiently.

In particular in the case of central processing, the data processing device 16 of the wind turbine 10 can be configured to send the collected data with a view to comparing the recorded data with anonymized data from other wind turbines and matching a fault condition with the abnormal behaviour through the comparison. Furthermore, the data processing device 16 can be set up to receive the fault condition.

Alternatively, these processes can be performed decentrally, in particular in the wind turbine 10, Particularly in the decentralized case, the data processing device 16 of the wind turbine 10 can be configured to compare the collected data with anonymized data from other wind turbines, match a fault condition with the abnormal behaviour through the comparison and output the fault condition to the wind turbine

According to embodiments described herein, the data may be anonymized before the comparison is performed. This allows a market participant to upload their data without possibility of tracing it back to them.

According to embodiments described herein, a cluster system can determine similarities of the collected data with other data that are related to abnormal behaviour of wind turbine 10, wherein the similarities are determined in particular with an unsupervised learning method.

In particular, the collected data and/or the anonymized data can be tabular data. The tabular data may have a timestamp. Furthermore, different data types, e.g. tabular and non-tabular data, can be used. This allows different data to be included, which can improve the prediction result.

According to embodiments described herein, the system can also include a, particularly decentralized, terminal 30. The terminal 30 can be set up to receive data from the online-based storage and server service 20, In particular, the terminal 30 can be set up to receive data that was previously sent from the wind turbine 10 to the online-based storage and server service 20 and/or to receive and output a fault condition. In practice, the data from the wind turbine 10 and fault conditions can be made available to other devices, in particular in real time.

The terminal 10 can, for example, also be another wind turbine in the same or another wind farm. In practice, data can be exchanged between several wind turbines. Furthermore, the wind turbine 10 can also receive data from the online-based storage and server service 20. The data can be data that the wind turbine 10 has previously uploaded itself. This can be, for example, historical data and/or data that has been further processed, which has been further processed in particular in the online-based storage and server service 20. In addition, the online-based storage and server service 20 can also send other data to the wind turbine 10. This can be the data from other wind turbines, but also software updates, for example for the sensors 11, 12, 13, 14, 15, the data processing device 16 and/or the network interface 18. Thus, the data processing device 16 can be system-specific and remotely adjusted over time. Moreover, findings that arise in the online-based storage and server service 20 can be transferred to other wind turbines.

Furthermore, the system can be set up to communicate with a SCADA system 40. For example, the system, in particular the online-based storage and server service 20, can be connected to the SCADA system 40 via an interface such as an API (“Application Programming Interface”). The SCADA system 40 can be a 2nd level SCADA system, for example. In practice, after the data has been transferred to the cloud, in addition to providing the data, it is also possible to integrate the data into an existing second level SCADA software via an API.

According to embodiments described herein, the method may further include connecting the data processing device 16 to the data network. The data processing device 16 can be connected to the data network via a network interface 18 as described herein.

FIG. 5 shows a system 200 for monitoring a wind turbine. The system 200 can in particular be set up to carry out methods described herein and have devices described herein.

FIG. 5 shows, for example, a client 210, a supplier 220, a client/supplier 230, a number of computer systems 240, a central memory 250 and a database 260 which can be connected to one another via the method described herein. The client 210, the supplier 220 and/or the client/supplier 230 can be operators of a wind turbine 10 or a wind farm 100, for example. In particular, the client 210, the supplier 220 and/or the client/supplier 230 can be a wind turbine 10 described herein or have or operate one. The multiple computer systems may belong to the online storage and server service 20 or to the client 210, supplier 220 or a client/supplier 230 in whole or in part. Furthermore, the central memory 250 and/or the database 260 can belong to the online-based memory and server service 20 in whole or in part. In particular, the elements shown can be connected to one another via the online-based storage and server service 20.

The client 210 can send collected data from a wind turbine 10, which is in particular related to an abnormal behaviour of the wind turbine 10. The supplier 220 can already have provided data that is stored in the central storage 250 and/or the database 260. The database 260 can in particular be a semantic database and can be used for comparing the data sent by the client 210 with the data already supplied and to match a fault condition with this data. These operations can be performed on at least one of the multiple computer systems 240, for example. The associated fault condition can then be sent back to the client 210.

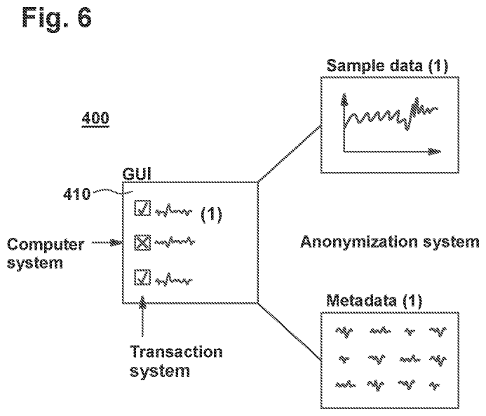

FIG. 6 shows an exemplary graphical interface 410 of a computer program product 400 according to embodiments.

The computer program product 400 can include an algorithm that is set up to perform the following based on collected data that is related to an abnormal behaviour of a wind turbine 10: comparing the collected data with anonymized data from other wind turbines; matching a fault condition with the abnormal behaviour through the comparison, and outputting the fault condition.

In particular, the computer program product 400 can be executed on the online-based storage and server service 20, The graphical interface 410 can be displayed on the wind turbine 10 and/or the terminal 30. The fault can also be output on the wind turbine 10 and/or the terminal 30. According to embodiments described herein, the algorithm may be capable of learning.

In practice, customers can, for example, manually select a problem in their wind turbines 10 via the graphical interface 410, in particular a dashboard thereof, which triggers data collection. The data may be linked or compared to other events and data as described herein. And a list of other similar events can be output to the graphical interface 410.

In summary, the present disclosure can solve the underlying problem through one or more of the following factors.

Current efforts in the industry to obtain a common framework for evaluating anonymized data can be served by the present disclosure, participants may be offered a reference to evaluate their processes. This is a step that makes it possible to find participants with similar interests and problems.

Participants in the methods and system described herein can search for statistically significant data, i.e. wondering what data is needed for model development.

An anonymized source of wind turbine events can be provided, allowing market participants to create internally supervised learning models to monitor their wind turbines.

An algorithm can be provided that selects the most relevant available data to complement the information held by each market participant.

According to embodiments described herein, several possible fault conditions can be matched. A probability or similarity can be matched with the multiple possible fault conditions, which fault conditions can be indicated together. Since the similarity to the available data with the event of interest can be classified, specifically described in metadata and provided as a template before the transaction is completed, participants can limit their requests based on the quality of the information.

Participants can store their data centrally on a marketplace (server in the cloud) or own their data completely and store it locally for complete anonymization (e.g. via blockchain).

Participants can supplement their tabular data (e.g. sensor measurements) with non-tabular data (e.g. videos) retrieved by the algorithms to add complexity to their internal modelling.

Participants can assess the unique nature of their data set in relation to the entirety of data available in the market, which allows them to carry out price transactions efficiently.

A single point can be created for market participants to exchange data of common interest in an anonymized format.

The cloud-based system allows all market participants to access and store their data with industry-standard security quality, either centrally or locally (decentralized).

Algorithmic selection of data and metadata based on similarity simplifies pre-processing activities and eliminates the risk of not having relevant data for internal modelling and monitoring.

A mixture of tabular (time series) and non-tabular (videos, images) data can be described in metadata of stored events and returned in a ranked form per request, which can optimize computational effort on “smart” data sets with large statistical significance.

Transactions can be completed after a similarity ranking has been established, allowing g customers to sample data before confirming transactions.

Time efficiency can improve as there is no need to negotiate with multiple parties (without access to assessing the relevance of the data) as there is a single market for all participants.

The cost-efficiency of transactions can be improved as both providers and customers can assess the unique nature of their data sets in an open but secure and anonymized data market.

The present disclosure thus provides a technical solution that enables all market participants to efficiently and securely access, search, share and obtain relevant (anonymized) data sets for modelling low-probability failure events. Furthermore, the algorithm can select tabular and non-tabular data from a semantic database (either centralized or distributed) to associate and classify events based on similarity for subsequent building of supervised learning models.

It should be noted at this point that the aspects and embodiments described herein can be suitably combined with each other and that individual aspects can be left out where it is meaningful and possible within the scope of the action by the person skilled in the art, Modifications and additions of the aspects described herein are known to the person skilled in the art.

1. A method for monitoring a wind turbine, the method comprising:
collecting, with a processor, data related to an abnormal behaviour of the wind turbine;
comparing, with the processor, the collected data with anonymized data from other wind turbines;
matching, with the processor, a fault condition with the abnormal behaviour through the comparison; and
outputting, with the processor, the fault condition to the wind turbine.

2. A method according to claim 1, wherein the comparison and the matching are carried out centrally and/or decentrally on a server.

3. A method according to claim 1,
wherein the collected data is anonymized before the comparison is carried out.

4. A method according to anyone of claim 1, wherein a cluster system determines similarities of the collected data for abnormal behaviour of the wind turbine with other data that are related to abnormal behaviour of wind turbines, wherein the similarities are determined in particular with an unsupervised learning method.

5. A method according to claim 1, in which the collected data and/or the anonymized data are tabular data, and wherein in particular the tabular data has a timestamp.

6. A method according to claim 1, wherein the abnormal behaviour corresponds to a fault condition in the wind turbine that is to be identified.

7. A method according to anyone of claim 1, wherein the data is collected with at least one sensor of the wind turbine, wherein in particular the at least one sensor is a fiber optic sensor.

8. A system for monitoring a wind turbine, wherein the system is configured to carry out the method according to claim 1.

9. A wind turbine, comprising:
at least one sensor configured for collecting data related to abnormal behaviour of a wind turbine; and
a data processing device configured to:
compare the collected data with anonymized data from other wind turbines;
match a fault condition with the abnormal behaviour through the comparison; and
output the fault condition to the wind turbine.

10. A wind turbine comprising:
at least one sensor configured for collecting data related to abnormal behaviour of a wind turbine; and
a data processing device configured to:
send the collected data for comparison of the collected data with anonymized data from other wind turbines and match a fault condition with the abnormal behaviour through the comparison; and
receive the fault condition.

11. A computer-readable storage medium storing a set of instructions to implement an algorithm, which, based on recorded data that is related to an abnormal behaviour of a wind turbine, the set of instructions to direct a processor to:
compare the collected data with anonymized data from other wind turbines;
match a fault condition with the abnormal behaviour through the comparison; and
output the fault condition to the wind turbine.

12. A computer-readable storage medium according to claim 11, wherein the algorithm is capable of learning.

13. A computer-readable storage medium according to claim 11, wherein to output the fault condition to the wind turbine, the set of instructions directs the processor to display the fault condition on at least one of a graphical display of the wind turbine or a graphical display of a terminal in communication with the wind turbine.

14. A computer-readable storage medium according to claim 11, wherein to output the fault condition to the wind turbine, the set of instructions direct the processor to transmit the fault condition to at least one of the wind turbine or a terminal in communication with the wind turbine.

15. A wind turbine according to claim 10, wherein the data processing device is further configured to:
display the fault condition on at least one of a graphical display of the wind turbine or a graphical display of a terminal in communication with the wind turbine.

16. A wind turbine according to claim 10, wherein the data processing device is further configured to:
transmit the fault condition to a terminal in communication with the wind turbine.

17. A wind turbine according to claim 9, wherein to output the fault condition to the wind turbine, the data processing device is configured to display the fault condition on at least one of a graphical display of the wind turbine or a graphical display of a terminal in communication with the wind turbine.

18. A wind turbine according to claim 9, wherein to output the fault condition to the wind turbine, the data processing device is configured to transmit the fault condition to a terminal in communication with the wind turbine.

19. A method according to claim 1, wherein outputting, with the processor, the fault condition to the wind turbine comprises:
displaying, with the processor, the fault condition on at least one of a graphical display of the wind turbine or a graphical display of a terminal in communication with the wind turbine.

20. A method according to claim 1, where outputting, with the processor, the fault condition to the wind turbine comprises:
transmitting, with the processor, the fault condition to at least one of the wind turbine or a terminal in communication with the wind turbine.
